(19) United States
(12) Patent Application Publication
(10) Pub. No.: US 2002/0021271 A1
(43) Pub. Date: Feb. 21, 2002

(54) LIQUID CRYSTAL DISPLAY DEVICE AND METHOD FOR DRIVING THE SAME

(76) Inventor: ATSUSHI SAKAMOTO, YAMABE-GUN (JP)

Correspondence Address: Dike Bronstein Roberts & Cushman, Intellectual Property Practice Group, EDWARDS & ANGELL, P O Box 9169, Boston, MA, 02209, US

(21) Appl. No.: 09/145,110

(22) Filed: Sep. 2, 1998

(30) Foreign Application Priority Data
Sep. 4, 1997 (JP) 9-240082

(51) Int. Cl. G09G 3/36

(52) U.S. Cl. 345/87

(57) ABSTRACT

A liquid crystal display device of the present invention includes: a liquid crystal panel having a plurality of signal electrodes and a plurality of scanning electrodes which are arranged to cross each other with a liquid crystal layer interposed therebetween; a scanning side driving circuit for sequentially applying scanning voltages to the plurality of scanning electrodes; a signal side driving circuit for applying voltages to the plurality of signal electrodes, the voltage being determined by superimposing, for a corresponding scanning period, a correction voltage such as to correct a variation in an effective voltage due to a waveform distortion occurring in the scanning voltage over a signal voltage corresponding to display data; and a voltage generation circuit for generating voltages required for driving the signal side driving circuit and the scanning side driving circuit.

### BACKGROUND OF THE INVENTION

1. Field of the Invention

The present invention relates to a passive matrix type liquid crystal display device for use in a personal computer, a word processor, or the like, and a method for driving the same.

2. Description of the Related Art

In recent years, as the popularity of personal computers and word processors has grown, CRTs, are typically large in size and consume substantial power, have been replaced by liquid crystal display devices, which are light in weight, thin, and can be battery-driven.

Known methods for driving such liquid crystal display devices include a passive matrix driving method and an active matrix driving method. A passive matrix driving liquid crystal display (LCD) device is generally easier to produce and lower in cost than an active matrix LCD device since a non-linear element in not required in the passive matrix driving LCD device for each of the pixels arranged in a matrix as in the active matrix LCD device. In the passive matrix LCD device, however, as display capacitance (e.g., the liquid crystal capacitance) increases, there occurs some display non-uniformity (e.g., crosstalk) depending upon the display pattern, which tends to lower display quality.

Hereinafter, the display non-uniformity will be described by way of example of the passive matrix type LCD devices which utilizes a voltage averaging method.

First, a structure of a conventional passive matrix type LCD device is described with reference to FIG. 12. The conventional passive matrix type LCD device includes: a liquid crystal panel 101 where a plurality of scanning electrodes Y1 to Y8 and a plurality of signal electrodes X1 to X8 are arranged to cross each other. The device also includes a scanning side driving circuit 103 for linear-sequential application of scanning voltages to the scanning electrodes Y1 to Y8. A signal side driving circuit 102 applies signal voltages, which are determined based on the display data, to the signal electrodes X1 to X8. A power circuit 104 generates voltages required for driving the scanning side driving circuit 103 and the signal side driving circuit 102. A control circuit 105 controls the scanning side driving circuit 103 and the signal side driving circuit 102.

The passive matrix LCD device is driven in the following manner. The scanning electrodes Y1 to Y8 are sequentially scanned by the scanning side driving circuit 103. A selection voltage V1 or V5 supplied from the power circuit 104 is applied to the selected one of the scanning electrodes Y1 to Y8, and a non-selection voltage V3 also supplied from the power circuit 104 is applied to the non-selected ones of the scanning electrodes Y1 to Y8. The signal aide driving circuit 102 applies an ON voltage or an OFF voltage supplied from the power circuit 104 to each of the signal electrodes X1 to X8 so as to correspond to the display data.

The control circuit 105 outputs display data D, a data shift clock CK, a scanning clock LP and an alternating signal FR to the signal side driving circuit 102, and outputs the scanning clock LP, a scanning start signal FLM and the alternating signal FR to the scanning side driving circuit 103.

It is assumed, for discussion purposes only, that there are eight scanning electrodes and eight signal electrodes, and the electrodes are driven at a duty cycle of ⅛, and the inversion signal used for alternating waveform driving has a cycle corresponding to three scanning lines.

Next, the operation of the driving circuits of the passive matrix LCD device having such a structure will be described with reference to timing diagrams illustrated in FIGS. 13A to 13G.

FIGS. 13A to 13G illustrate ideal voltage waveforms to be applied to pixel A (at the intersection of the signal electrode X2 and the scanning electrode Y2) and pixel B (at the intersection of the signal electrode X3 and the scanning electrode Y2) on the liquid crystal panel 101 illustrated in FIG. 12. The pixels indicated by ∘ are lit, and those indicated by ● are not lit.

FIG. 13A illustrates the scanning clock LP. FIG. 13B illustrates the alternating signal FR. FIG. 13C illustrates an ideal signal voltage waveform applied to the signal electrode X2 shown in FIG. 12. FIG. 13D illustrates an ideal signal voltage waveform applied to the signal electrode X3 shown in FIG. 12. FIG. 13E illustrates an ideal scanning voltage waveform applied to the scanning electrode Y2. FIG. 13F illustrates an ideal voltage waveform applied to pixel A. FIG. 13G illustrates an ideal voltage waveform applied to pixel B.

In an ideal state, as can be seen from FIGS. 13F and 13G, the same effective voltage is applied to pixel A and pixel B. Therefore, there should be no difference in transmission between these pixels.

However, when conducting a stripe display, e.g., when a gray line (formed of alternating white (lit) pixels and black (not lit) pixels) is drawn on a white background in an actual liquid crystal panel, as illustrated in FIG. 12; a white pixel along the gray line (e.g., pixel B) will be darker (as indicated by way of hatching in the figure) than a white pixel in the background (e.g., pixel A), thereby causing crosstalk and thus display non-uniformity.

Among other problems associated with the passive matrix type LCD device, crosstalk has been one of the moot important problems needing to be solved because crosstalk considerably lowers display quality.

A mechanism of how crosstalk occurs is now described.

FIG. 14A illustrates the scanning clock LP. FIG. 14B illustrates the alternating signal FR. FIG. 14C illustrates an ideal signal voltage waveform applied to the signal electrode X2 shown in FIG. 12. FIG. 14D illustrates an ideal signal voltage waveform applied to the signal electrode X3 shown in FIG. 12. No voltage difference is recognized between the signal electrodes X2 and X3, comparing their effective voltage values. However, in the actual LCD device 101, signal voltages having blunt waveforms are applied, as illustrated in FIGS. 14E and 14F, due to internal resistance of the signal side driving circuit 102 and resistance component and liquid crystal capacitance component of the signal electrodes X1 to X8. In FIGS. 14E and 14F, the blunt waveforms (which are charge-discharge waveforms to the capacitor) are simplified and represented by straight lines for ease of understanding.

As can be seen from FIGS. 14E and 14F, the signal voltage at the signal electrode X3 switches more often than the signal electrode X2 and thus has more blunt portions than the signal electrode X2. As a result, the effective value of signal voltage applied to the signal electrode X3 is reduced accordingly.

Referring to FIG. 12 again, a pixel along the signal electrode X3 (e.g., pixel B) will appear darker than a pixel along the signal electrode X2 (e.g., pixel A), which will be recognized as crosstalk.

There have been proposed methods to reduce crosstalk, where the signal voltage application waveform is inverted for a certain length of time during a time period for which one scanning electrode (hereinafter, referred to also as the “scanning line”) is driven. For example, Japanese Laid-open Publication Nos. 5-333315 and 4-276794 disclose such methods (hereinafter, referred to also as the “first method” and the “second method”, respectively). According to these methods, the signal application waveform (voltage level) is inverted for a certain length of time during a time period for which one scanning electrode is driven, so as to create some blunt portions in the signal voltage waveform even though the signal voltage waveform determined based on the display data did not originally have any blunt portion. In accordance with such methods, the blunt waveforms of the signal voltages can be made somewhat uniform, thereby reducing crosstalk in a stripe display.

Japanese Laid-open Publication No. 7-98825 discloses another method (hereinafter, referred to also as the “third method”) which reduce the crosstalk in a stripe display by applying a correction voltage such as to correct a decrease in effective voltage due to the blunt waveform generated for each scanning period.

However, these methods have the following problems.

The first and second methods above achieve some crosstalk reduction by treating blunt portions in waveforms so that the effective signal voltages become uniform across the display area at the lower level of effective signal voltage along the stripe. In these methods, the number of waveform inversions in the signal voltage applied to a signal electrode in the background is inevitably large. Therefore, many waveform distortions occur in the scanning line, thereby increasing the amount of a different type of crosstalk (e.g., a top portion and a bottom portion of a vertical black line drawn on a white background become brighter than the rest of the line). Moreover, in a large liquid crystal panel, the degree of crosstalk significantly differs between the upper and lower sides of the panel or between the left and right sides thereof. Furthermore, since the number of waveform inversions in the signal voltage is considerably large, the power consumption level is always at substantially the maximum level, regardless of the display pattern.

These problems have been solved in the third method. However, as the size and the definition of the liquid crystal panel has increased in recent years, there has been a demand for accordingly increasing the display quality thereof, whereby this method does not always provide sufficient correction. For example, when the vertical stripe is wide, signal voltage levels for many signal electrodes change simultaneously, thereby generating a great waveform distortion in the scanning voltage via the capacitors of the liquid crystal layer. As a result, the effective voltage to be applied to a pixel further decreases. Thus, when conducting such a stripe display, the crosstalk may be increased. This will be described in detail with reference to FIGS. 15A and 15B.

Referring to FIG. 15A, Yn denotes a scanning electrode, and X1 to X8 respectively denote signal electrodes. Consider a case where the voltages of seven signal electrodes X2 to X5 simultaneously change from an H level to an L level, while the voltage of the electrode X1 remains at the H level. At the moment the signal voltages of the signal electrodes X2 to X5 change from the H level to the L level, due to the capacitors C2 to C8 of the liquid crystal layer and the resistors R1 to R8 of the scanning electrodes, waveform distortions (indicated by V1 to V8 in FIG. 15A) occur on the scanning electrodes; FIG. 15B illustrates waveforms applied to the pixels which art respectively designated as “Xn-Vn”. As illustrated in FIG. 15B, for the seven signal electrodes X2 to X8 except for the signal electrode X1, the effective voltage greatly decreases due to the waveform distortion of the scanning voltage as well as the blunt portions in the signal voltage waveform. Moreover, since the resistors R1 to R8 are serially connected to one Another between the signal electrode X1 and the signal electrode X8, the magnitude of the waveform distortion gradually increases from one end to the other, e.g., the closer to the right edge of the liquid crystal panel, the more greatly the effective voltage decreases.

The third method does not provide a sufficient effect for such a problem, because the method aims to only correct the blunt waveform in the signal voltage.

Moreover, as is apparent from the above discussion, since the degree of crosstalk greatly depends upon the characteristics of the liquid crystal panel (e.g., the electrostatic capacitors (liquid crystal capacitors) C1 to C8), it varies depending upon those factors which affect the characteristics of the liquid crystal panel (e.g., the temperature, the driving voltage and the frame frequency). Therefore, even if the correction of the crosstalk is properly adjusted under a certain condition, much an adjustment may not be adequate for other conditions, under which such an adjustment may rather increase the crosstalk.

### SUMMARY OF THE INVENTION

According to one aspect of this invention, a liquid crystal display device includes: a liquid crystal panel having a plurality of signal electrodes and a plurality of scanning electrodes which are arranged to cross each other with a liquid crystal layer interposed therebetween; a scanning side driving circuit for sequentially applying scanning voltages to the plurality of scanning electrodes; a signal side driving circuit for applying voltages to the plurality of signal electrodes, the voltage being determined by superimposing, for a corresponding scanning period, a correction voltage such as to correct a variation in an effective voltage due to a waveform distortion occurring in the scanning voltage over a signal voltage corresponding to display data; and a voltage generation circuit for generating voltages required for driving the signal aide driving circuit and the scanning side driving circuit.

In one embodiment of the invention, the correction voltage is generated as a function based on a correction voltage generation signal predetermined in accordance with prescribed data.

In one embodiment of the invention, the correction voltage in a pulse voltage, and a pulse width or pulse amplitude of the pulse voltage is changed in accordance with an amount of change of the display data over consecutive scanning periods.

In one embodiment of the invention, the correction voltage is a pulse voltage, and a pulse width or pulse amplitude of the pulse voltage is changed for each one or more of the plurality of signal electrodes in accordance with a distance between the one or more of the plurality of signal electrodes and a scanning side driving circuit which is connected to at least one end of the plurality of scanning electrodes.

In one embodiment of the invention, the voltage generation circuit: generates at least the signal voltage and a corrected signal voltage, which is obtained by superimposing the correction voltage over the signal voltage; and selectively supplies one of the signal voltage and the corrected signal voltage to the signal side driving circuit based on whether the correction voltage is superimposed over the signal voltage.

In one embodiment of the invention, the voltage generation circuit; generates at least the signal voltage and a corrected signal voltage, which is obtained by superimposing the correction voltage over the signal voltage; supplies the signal voltage and the corrected signal voltage to the signal side driving circuit; and selects one of a plurality of output lines based on whether the correction voltage is superimposed over the signal voltage.

In one embodiment of the invention, the prescribed data comprises at least one of: a temperature of an environment in which the liquid crystal display device is placed; a temperature of the liquid crystal display device itself; a driving voltage applied to the liquid crystal display device; and a frame frequency at which the liquid crystal display device is driven.

According to another aspect of this invention, a method driving a liquid crystal display device is provided. The device includes: a liquid crystal panel having a plurality of signal electrodes and a plurality of scanning electrodes which are arranged to cross each other with a liquid crystal layer interposed therebetween; a signal side driving circuit for applying a voltage, required for performing a display on the liquid crystal panel, to the plurality of signal electrodes; a scanning side driving circuit for sequentially applying a scanning voltage to the plurality of scanning electrodes: a voltage generation circuit for generating voltages required for driving the signal side driving circuit and the scanning aide driving circuit. The method includes the steps of: (a) generating a correction voltage generation signal, which is used for weighting a correction amount for correcting an amount of change of the display data over at least two consecutive scanning periods; (b) obtaining a correction voltage which is a pulse voltage whose pulse width or pulse amplitude is variable based on the correction voltage generation signal; (c) superimposing the correction voltage over the signal voltage corresponding to the display data for performing a display on the liquid crystal panel; and (d) supplying, to the plurality of signal electrodes, the signal voltage over which the correction voltage is superimposed.

In one embodiment of the invention, the prescribed data comprises at least one of: a temperature of an environment in which the liquid crystal display device is placed; a temperature of the liquid crystal display device itself; a driving voltage applied to the liquid crystal display device: and a frame frequency at which the liquid crystal display device is driven.

In one embodiment of the invention, the correction voltage generation signal is generated for further weighting a correction amount for correcting an amount of change of the effective voltage due to a waveform distortion occurring in the scanning voltage depending upon a distance between each of the plurality of signal electrodes and the scanning driving circuit.

Hereinafter, the function of the present invention will be described.

In the liquid crystal panel of the LCD device of the present invention, each intersection of a signal electrode and a scanning electrode corresponds to a pixel of the liquid crystal panel. Each pixel corresponds to an intersection of a signal electrode to which a signal voltage is applied and a scanning electrode to which a scanning voltage is applied is lit, thereby displaying desired data.

Typically, when the display data for a scanning electrode (scanning line) is varied from the display data for the preceding scanning line, a waveform distortion is generated in the scanning voltage according to the variation therebetween. In the present invention, however, a correction voltage (pulse) whose pulse amplitude or pulse width Is changed according to the variation in the display data is applied from the signal electrode side, whereby it in possible to correct the effective voltage decrease due to the waveform distortion generated in the scanning voltage. Thus, it is possible to provide a substantially constant effective voltage for all the pixels, thereby greatly reducing crosstalk.

Crosstalk occurs due to a change in capacitance of the liquid crystal layer, and such a change in capacitance is due to factors such as: the temperature of the environment where the LCD device is used; the temperature of the LCD device itself; the driving voltage applied to the LCD device; end the frame frequency at which the LCD device is driven. By changing the pulse amplitude or the pulse width of the correction voltage in accordance with these factors, it is possible to effectively adjust the correction even when these factors change, and thus to greatly reduce crosstalk under any conditions.

Moreover, the pulse amplitude or the pulse width of the correction voltage may be controlled in accordance with the distance from the scanning side driving circuit connected to at least one end of the scanning electrode so that each one or more signal electrodes have a voltage value which differs from that of the others. In such a case, it is possible to make corrections so as to address the situation where the distortion on the scanning electrode varies depending upon the distance from the scanning side driving circuit due to the varying resistance of the scanning electrode. Thus, it is possible to effectively reduce crosstalk entirely across the screen.

Furthermore, the voltage veneration circuit may function to generate at least one level of correction voltage in addition to a normal signal voltage, which are all supplied to the signal side driving circuit, and may further be provided with a circuit for selecting a line through which the voltage output is supplied to the signal side driving circuit so as to output the correction voltage in place of the normal signal voltage for a predetermined length of time during the scanning period. In such a case, it is possible to correct, from the signal electrode side, the decrease in the effective voltage to a pixel due to the waveform distortion generated in the scanning electrode.

Alternatively, the voltage generation circuit may be designed to generate at least one level of correction voltage in addition to a normal signal voltage, which are all supplied to the signal side driving circuit, while the signal side driving circuit is designed to be capable of selectively outputting one of the normal signal voltage and the correction voltage. In such a case, again, it is possible to correct, from the signal electrode side, the decrease in the effective voltage to a pixel due to the waveform distortion generated in the scanning electrode.

Thus, the invention described herein makes possible the advantages of: (1) providing an LCD device in which it is possible to prevent crosstalk from occurring due to waveform distortion in a scanning voltage, or the like; and (2) providing a method for driving such an LCD device.

These and other advantages of the present invention will become apparent to those skilled in the art upon reading and understanding the following detailed description with reference to the accompanying figures.

### BRIEF DESCRIPTION OF THE DRAWINGS

FIG. 1 is a block diagram schematically illustrating a structure of an LCD device according to Example 1 of the present invention.

FIG. 2 is a block diagram schematically illustrating an internal structure of a signal side driving circuit provided in the LCD device according to Example 1 of the present invention.

FIG. 3A is a block diagram schematically illustrating a correction control circuit provided in the LCD device according to Example 1 of the present invention; and FIG. 3D is a timing diagram thereof.

FIGS. 4A to 4J are timing diagrams illustrating an operation of the LCD device according to Example 1 of the present invention.

FIGS. 5A to 5H are timing diagrams illustrating another example of correction voltage application according to the present invention.

FIG. 6 in a block diagram schematically illustrating a structure of an LCD device according to Example 2 of the present invention.

FIG. 7 is a block diagram schematically illustrating an internal structure of a signal side driving circuit provided in the LCD device according to Example 2 of the present invention.

FIG. 8 is a block diagram schematically illustrating an internal structure of a power circuit provided in the LCD device according to Example 2 of the present invention.

FIGS. 9A to 9K are timing diagrams illustrating an operation of the LCD device according to Example 2 of the present invention.

FIG. 10 provides timing diagrams illustrating another operation of the LCD device according to Example 2 of the present invention.

FIG. 11 is a block diagram schematically illustrating a structure of a correction control circuit provided in an LCD device according to Example 3 of the present invention.

FIG. 12 is a block diagram illustrating a structure of a conventional LCD device.

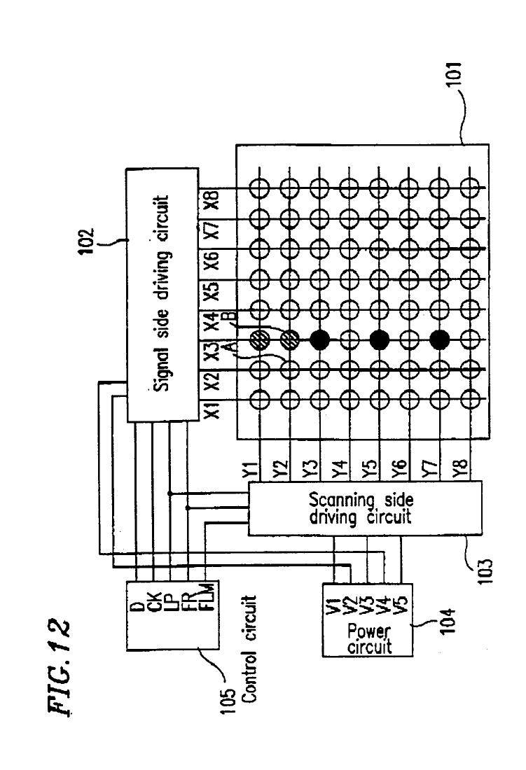

FIGS. 13A to 13G are timing diagrams illustrating an ideal operation of the conventional LCD device.

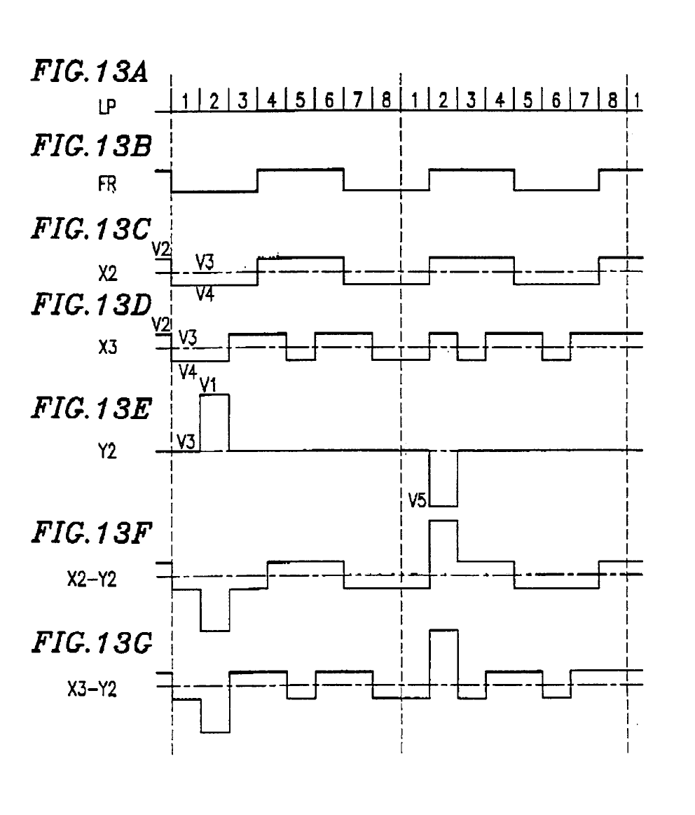

FIGS. 14 to 14F are timing diagrams illustrating a mechanism of how crosstalk occurs in the conventional LCD device.

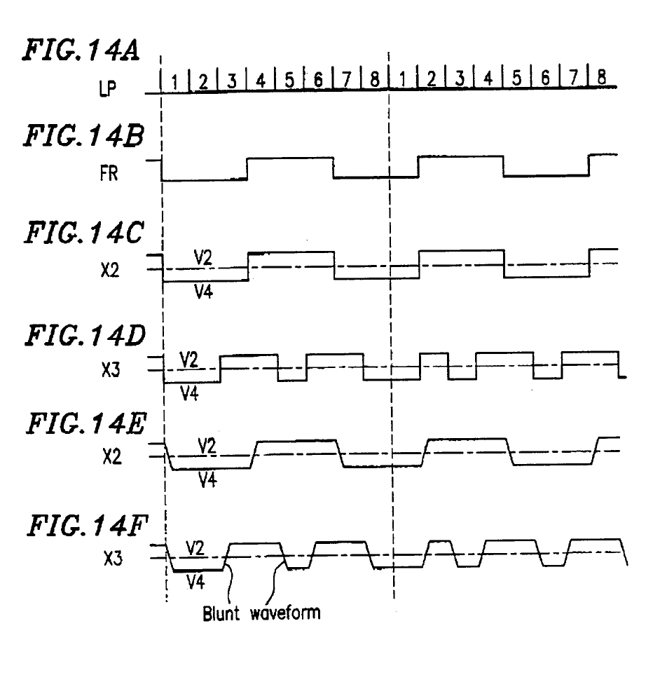

FIGS. 15A and 15B illustrate a mechanism of how crosstalk occurs in the conventional LCD device.

### DESCRIPTION OF THE PREFERRED EMBODIMENTS

### EXAMPLE 1

Hereinafter, Example 1 of the present invention will be described.

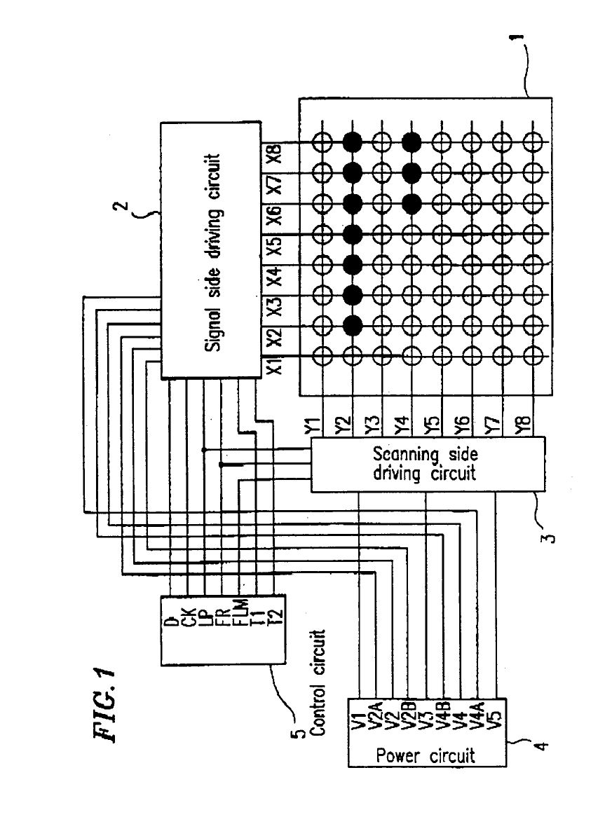

FIG. 1 is a block diagram schematically illustrating a structure of an LCD device according to Example 1 of the present invention.

The LCD device includes: a liquid crystal panel 1 where a plurality of scanning electrodes Y1 to Y8 and a plurality of signal electrodes X1 to X8 are arranged to cross each other. The LCD device also includes a scanning side driving circuit 3, serving as scanning side driving means, for linear-sequential application of scanning voltages to the scanning electrodes Y1 to Y8. A signal side driving circuit 2 serves as signal side driving means, for application of signal voltages, which are determined based on the display data, to the signal electrodes X1 to X8. A power circuit 4 serves as voltage generation means, for generating voltages required for driving the scanning side driving circuit 3 and the signal side driving circuit 2. A control circuit 5 controls the scanning side driving circuit 3 and the signal side driving circuit 2.

It is assumed in this example, for discussion purpose only, that there are eight scanning electrodes Y1 to Y8 and eight signal electrodes X1 to X8 and the electrodes are driven at a duty cycle of ⅛, and the inversion signal used for alternating current (AC) driving has a cycle corresponding to eight scanning lines. It should be understood that, in this example and in other examples of the present invention, the number of electrodes, or the like, is not limited to the above.

The basic operation of the driving method of this example is now described. The LCD device is driven in the following manner. The scanning side driving circuit 3 sequentially scans the scanning electrodes Y1 to Y8 in accordance with an input scanning clock LP and an input scanning start signal FLM. A selection voltage V1 or V5 supplied from the power circuit 4 is applied to the selected one of the scanning electrodes Y1 to Y8, and a non-selection voltage V3 supplied from the power circuit 4 is applied to the non-selected ones of the scanning electrodes Y1 to Y1. The signal side driving circuit 2 applies an ON voltage or an OFF voltage supplied from the power circuit 4 to each of the signal electrodes X1 to X8 so as to correspond to the display data. This basic operation of the driving method is the same as that in the conventional driving method.

Next, the present example will be further described focusing on its distinctive aspects over the conventional example.

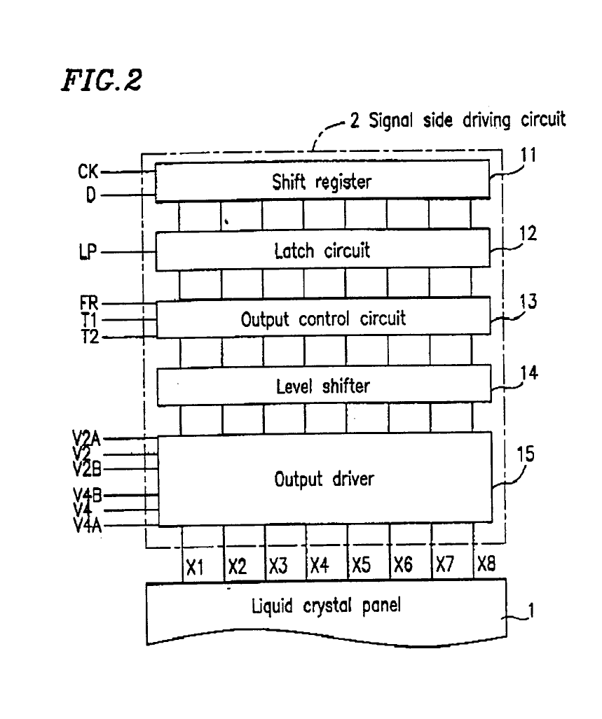

For example, as illustrated in FIG. 2, the signal side driving circuit 2 is shown. A shift register 11 transfers display data D based on a data shift clock CK. A latch circuit 12 stores the display data D for one scanning line based on the scanning clock LP after completely transferring the data for that scanning line. An output control circuit 13 outputs signals for output voltage selection based on the alternating signal FR. The LCD device also includes a correction period control signal T1 and a correction polarity control signal T2; a level shifter 14: and an output driver 15 for outputting to each signal electrode one of normal signal voltages V2 and V4 and correction voltages V2A, V2B, V4A and V4B based on the signals from the output control circuit 13. The correction voltages V2A, V2B, V4A and V4B, which are all supplied from the power circuit 4, have the following relationship: V2B<V2<V2A and V4A<V4<V4B.

The output control circuit 13 can be easily made using general-purpose logic circuits. The output control circuit 13 operates based on the following table of truth value (Table 1), and the output driver 15 is capable of selectively outputting to a signal electrode one of the normal signal voltages V2 and V4 and the correction voltages V3, V2B, V4A and V4B during the scanning period.

TABLE 1

| FR | D | T1 | T2 | Output voltage |
|---|---|---|---|---|
| L | L | L | L | V4 |
| | | | H | V4 |
| | | H | L | V4B |
| | | | H | V4A |
| | H | L | L | V2 |
| | | | H | V2 |
| | | H | L | V2B |
| | | | H | V2A |
| H | L | L | L | V2 |
| | | | H | V2 |
| | | H | L | V2A |
| | | | H | V2B |
| | H | L | L | V4 |
| | | | H | V4 |
| | | H | L | V4B |
| | | | H | V4A |

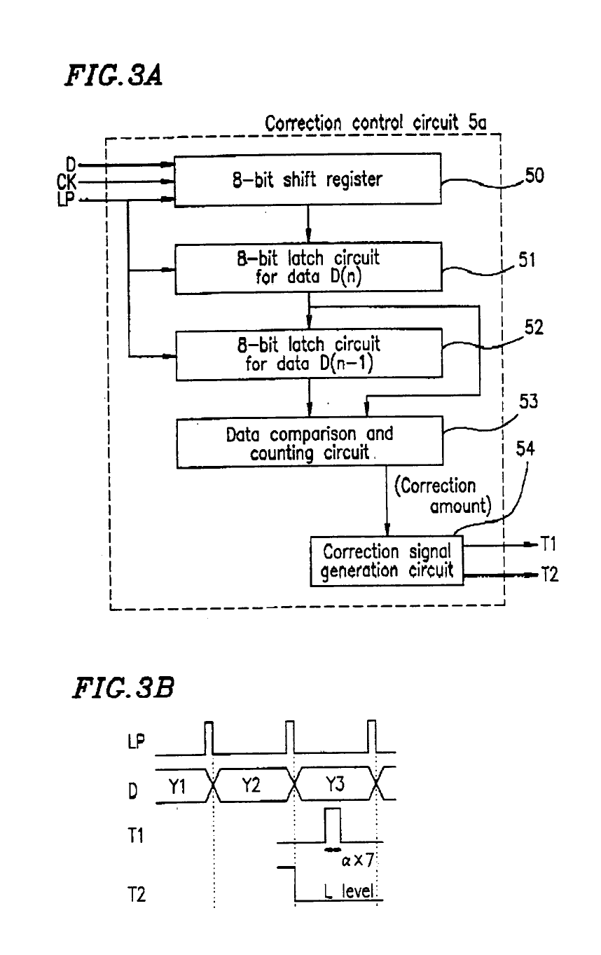

Next, referring to FIG. 3A, a correction control circuit 5a, provided in the control circuit 5 FIG. 1), for generating a correction period control signal T1 and a correction polarity control signal T2 is described.

The correction control circuit 5a includes: an 8-bit shift register for receiving the display data D, the data shift clock CK and the scanning clock LP; an 8-bit latch circuit 51 for latching display data DC(n) for the N^{th} scanning line, another 8-bit latch circuit 52 for latching display data D(n−1) for the N−1^{th} scanning line; a data comparison and counting circuit 53 for comparing the display data D(n) and D(n−1) latched in the respective latch circuits 51 and 52 and for calculating (counting) and outputting the difference {M(HL)−M(LH)} between the number of data points M(HL) changing from the H level to the L level and the number of data points M(LH) changing from the L level to the H level; and a correction signal generation circuit 54 for converting the counting result to the correction period control signal T1 and the correction polarity control signal T2.

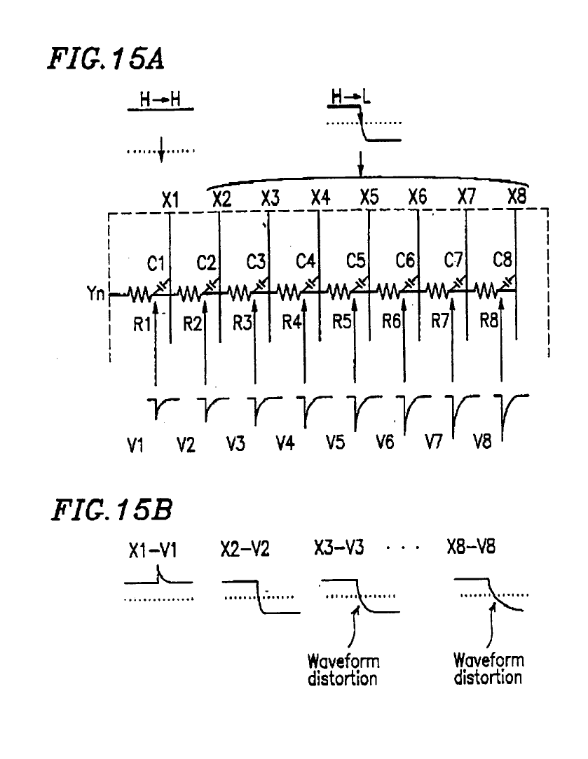

For example, referring also to FIG. 1, consider a came where the signal electrodes X1 to X5 are all ON for the scanning electrode Y1 and the seven signal electrodes X2 to X5 (but not X1) go OFF at the next scanning electrode Y2. In this case, the output of the data comparison and counting circuit 53 (FIG. 3A), e.g., the value {M(HL)−M(LH)} is −7. It is then possible to determine an appropriate correction amount while accounting for the magnitude and polarity of the voltage waveform distortion occurring on the scanning electrode aide, as illustrated in FIGS. 15A and 15B. Based on the determined correction amount, the correction signal generation circuit 54 (FIG. 3A) generates two correction voltage generation signals. In the illustrated instance, the correction signal generation circuit 54 generates a correction period control signal T1 having a pulse width of α×7 and a correction polarity control signal T2 being at the L level, corresponding to the negative polarity of the voltage waveform distortion.

In such an operation, the data comparison and counting circuit 53 determines (counts) the difference 7 with a variable frequency oscillator, for example. The correction signal generation circuit 54 multiplies the counting result 7 by the proportional constant α, thereby obtaining the pulse width α×7. The proportional constant α may be determined by, for example, adjusting the frequency while actually viewing the display.

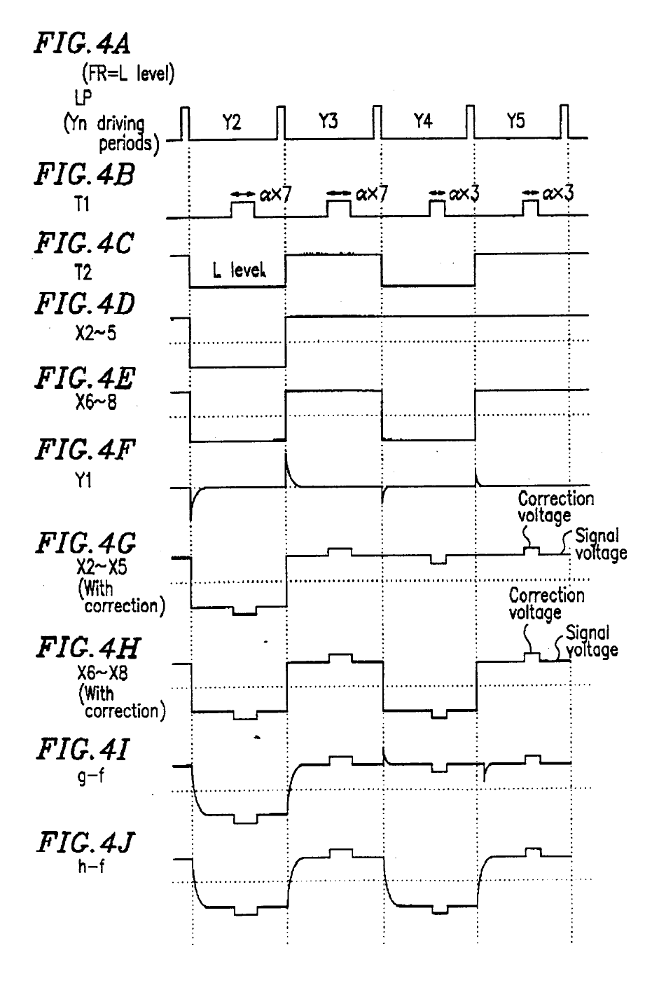

Similarly, the difference between Y3 and Y4 is −3, whereby the correction period control signal T1 has a width of α×3 while the correction polarity control signal T2 is at the L level. This is illustrated in FIGS. 4B and 4C.

The correction voltage generation signals, e.g., the correction period control signal T1 and the correction polarity control signal T2, are provided to the signal side driving circuit 2 (FIG. 1). Based on the correction period control signal T1 and the correction polarity control signal T2, the signal side driving circuit 2 (FIG. 1) applies to the signal electrodes the respective signal voltages having the correction voltages as illustrated in FIGS. 4G and 4H.

Next, the operation of the signal side driving circuit 2 (FIG. 2) will be described referring to the timing diagrams of FIGS. 4A to 4J.

FIG. 4A illustrates the waveform of the scanning clock LP. FIG. 4B illustrates the waveform of the correction period control signal T1. FIG. 4C illustrates the waveform of the correction polarity control signal T2. FIG. 4D illustrates the waveform of the voltage applied to the signal electrodes X2 to X5 in accordance with the conventional driving method with no correction voltage. FIG. 4E illustrates the waveform of the voltage applied to the signal electrodes X6 to X8 in accordance with the conventional driving method with no correction voltage. FIG. 4F illustrates the waveform of the voltage applied to the scanning electrode side where waveform distortion occurs. FIG. 4G illustrates the waveform of the voltage applied to the signal electrodes X2 to X5 having correction voltages. FIG. 4H illustrates the waveform of the voltage applied to the signal electrodes X6 to X5 having correction voltages. FIG. 4I illustrates the waveform of the voltage applied to a pixel which is obtained from the waveforms 4G and 4F and has the correction voltages. FIG. 4J illustrates the waveform of the voltage applied to a pixel which is obtained from the waveforms 4H and 4F and has the correction voltages.

The correction voltages (FIGS. 4G and 4H) corresponding to the waveform distortion (FIG. 4F) of the voltage applied from the scanning electrode side are applied to a pixel from the signal electrode side, thereby compensating for the decrease in the effective voltage due to the waveform distortion in the scanning voltage. As a result, crosstalk can be greatly reduced.

In this example, two levels of correction voltage are generated for each voltage value (V2A and V2B for V2, and V4A and V4B for V4). However, in this and other examples, the number of levels of correction voltage to be generated for each voltage value is not limited to two. At least one level of correction voltage is generated whose value is determined based on the sign of the value obtained by the circuit 53.

Moreover, in this and other examples, the correction period (a length of time during which the correction voltage is to be applied) does not have to be a part of the scanning period, but can alternatively correspond to the entire scanning period, in which case the level of correction voltage should be lowered accordingly.

Furthermore, in this example, the variation in the waveform distortion along a scanning electrode due to the relative position in the liquid crystal panel is not accounted for. However, this may have to be accounted for particularly in a large liquid crystal panel. In such a case, it may be accounted for by providing finer correction by controlling the correction period in accordance with the distance from the particular signal electrode to the scanning side driving circuit 3 so that each one or more signal electrodes have a voltage value which differs from that of the others.

Particularly, in the case of FIGS. 15A and 15B, for example, the correction period can be gradually longer from the signal electrode X1 toward the signal electrode X8. Thus, it is possible to more reliably correct the influence of the waveform distortion occurring in the scanning voltage regardless of the position of the signal electrode with respect to the scanning side driving circuit 3.

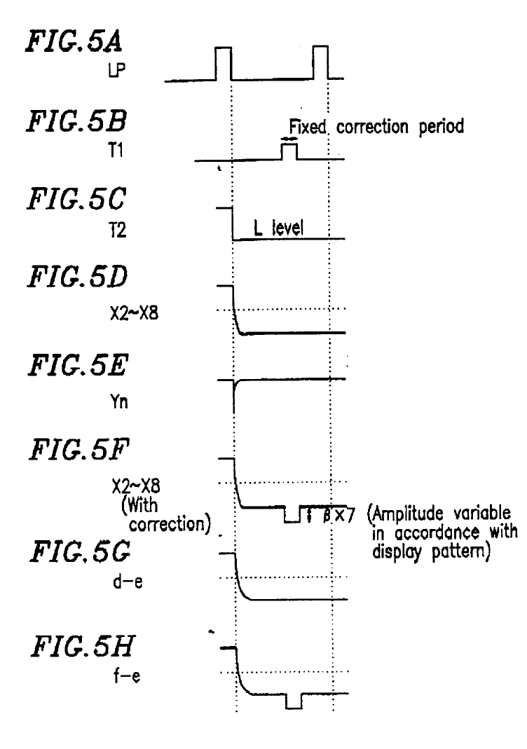

Moreover, in the present example, the correction period (pulse width) is varied so an to perform correction in accordance with the waveform distortion in the scanning voltage. However, the same effect can be provided also by, as illustrated in FIGS. 5A to 5H, fixing the correction period (FIG. 5B) while varying the correction voltage having an amplitude of β (proportional constant) ×7 in accordance with the waveform distortion in the scanning voltage. The proportional constant β can be determined in the same manner as the proportional constant α.

### EXAMPLE 2

Example 2 of the present invention is now described.

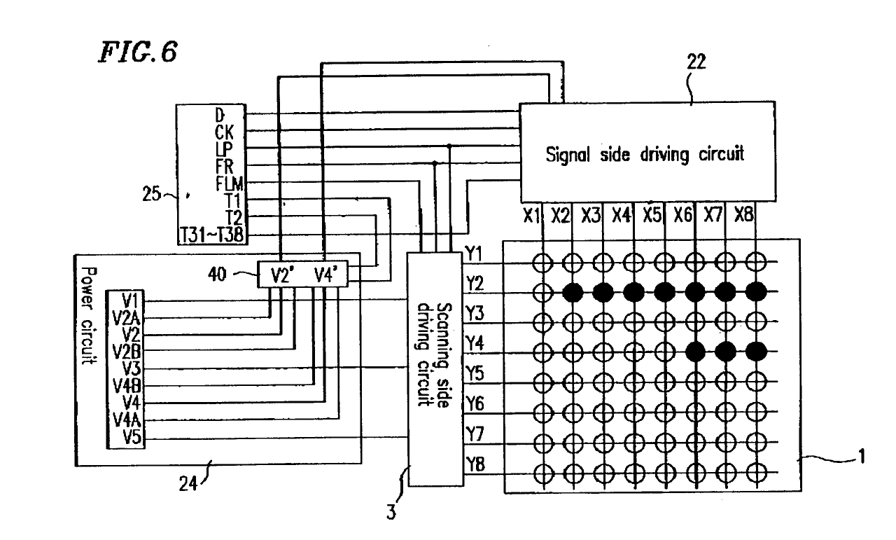

FIG. 6 is a block diagram schematically illustrating a structure of an LCD device according to Example 2 of the present invention. A liquid crystal panel 1 includes a plurality of scanning electrodes Y1 to Y8 and a plurality of signal electrodes X1 to X8 arranged to cross each other. A scanning side driving circuit 3 serves as scanning side driving means, for linear-sequential application of scanning voltages to the scanning electrodes Y1 to Y8. A signal side driving circuit 22 serves as signal side driving means, for application of signal voltages, which are determined based on the display data, to the signal electrodes X1 to X8. A power circuit 24 serves as voltage generation means, for generating voltages required for driving the scanning side driving circuit 3 and the signal side driving circuit 22. A control circuit 25 controls the scanning side driving circuit 3 and the signal side driving circuit 22.

It is assumed in this example, for discussion purpose only, that there are eight scanning electrodes Y1 to Y8 and eight signal electrodes X1 to X8, and the electrodes are driven at a duty cycle of ⅛, and the inversion signal used for alternating current (AC) driving has a cycle corresponding to eight scanning lines.

The basic operation of the driving method of this example will be described. The LCD device is driven in the following manner. The scanning side driving circuit 3 sequentially scans the scanning electrodes Y1 to Y8 in accordance with an input scanning clock LP and an input scanning start signal FLM. A selection voltage V1 or V5 supplied from the power circuit 24 is applied to the selected one of the scanning electrodes Y1 to Y8, and a non-selection voltage V3 supplied from the power circuit 24 is applied to the non-selected ones of the scanning electrodes Y1 to Y8. The signal side driving circuit 22 applies an ON voltage or an OFF voltage supplied from the power circuit 24 to each of the signal electrodes X1 to X5 to as to correspond to the display data. This basic operation of the driving method is the same as that in the conventional driving method.

Next, the present example will be further described focusing on its difference from the conventional example.

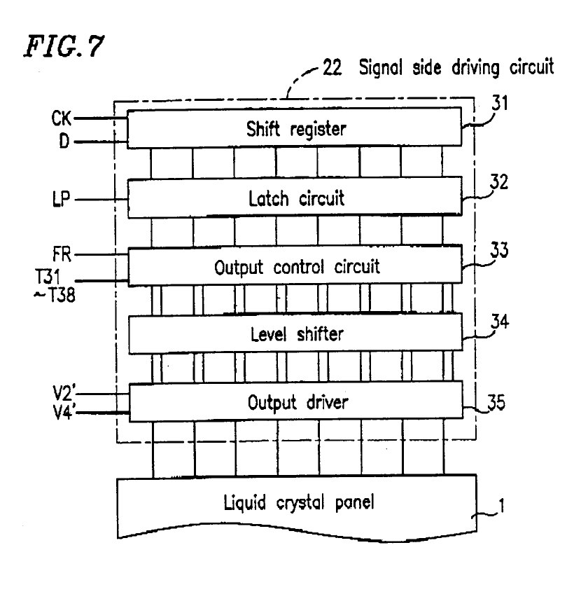

For example, as illustrated in FIG. 7, the signal side driving circuit 22 is shown. A shift register 31 transfers the display data D based on a data shift clock CK. A latch circuit 32 stores the display data D for one scanning line based on the scanning clock LP after completely transferring the data for that scanning line. An output control circuit 33 receives the outputs from the latch circuit 32 and outputting signals for output voltage selection based on the alternating signal FR and high impedance control signals T31 to T38, The LCD device also includes a level shifter 34; and an output driver 35 for outputting to each signal electrode one of signal voltages V2′ and V4′ and a high impedance output based on the signals from the output control circuit 33.

The output control circuit 33 can be easily made using general-purpose logic circuits. The output control circuit 33 operates based on the following table of truth value (Table 2) so as to select one of the three values, e.g., the voltage value of the V2′ power line, the voltage value of the V4′ power line and the high impedance value (HZ).

TABLE 2

| FR | D | T31˜T38 | Output voltage |
|---|---|---|---|
| L | L | L | V4′ |
| | | H | HZ |
| | H | L | V4′ |
| | | H | HZ |
| H | L | L | V2′ |
| | | H | HZ |
| | H₄ | L | V2′ |
| | | H | HZ |

Based on the above selection, the output driver 35 connects the V2′ output line to the signal electrode when the Y2′ power line voltage value is selected, while it connects the V4′ output line to the signal electrode when the V4′ power line voltage value is selected. When the high impedance (HZ) is selected, the output driver 35 connects the signal electrode to neither the V2′ output line nor the V4′ output line.

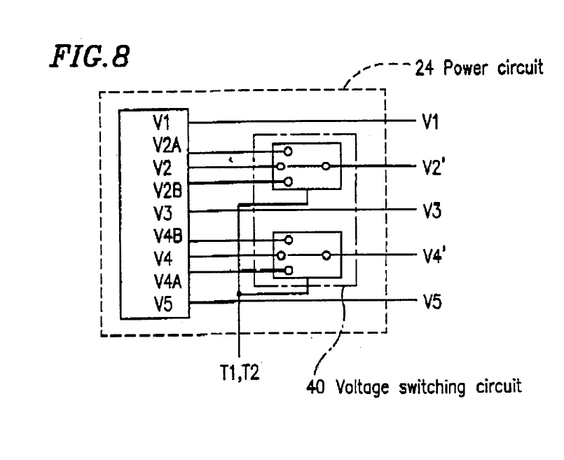

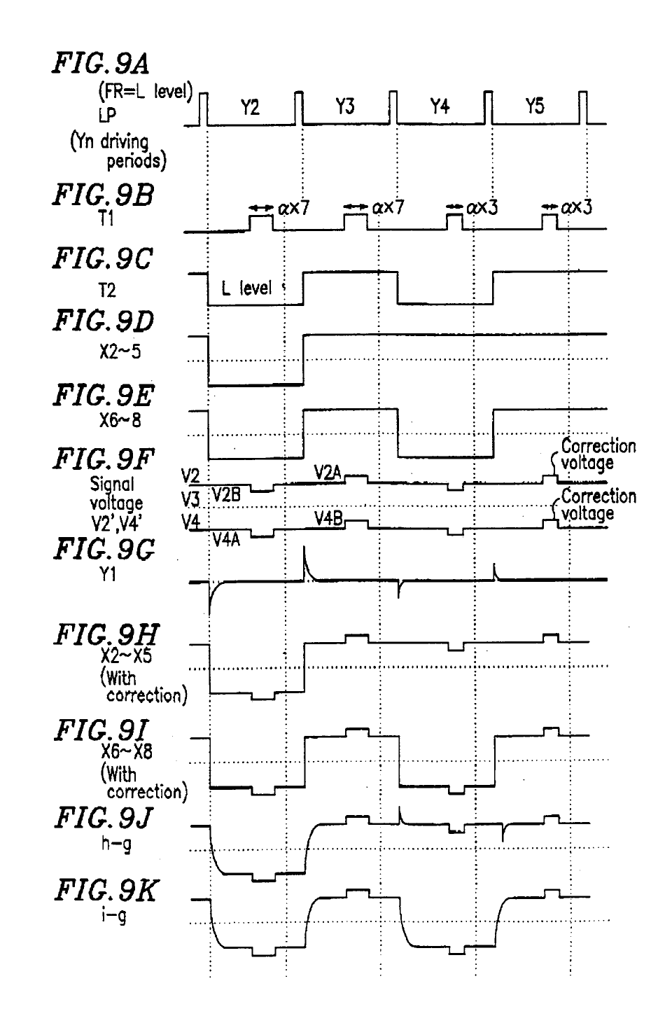

The voltages V2′ and V4′ are obtained by a voltage switching circuit 40 included in the power circuit 24 (FIG. 8), which superimposes the correction voltage V2A or V2B and V4A or V4B over the signal voltages V2 and V4, respectively, at the timing of the correction period control signal T1 and in accordance with the polarity as defined by the correction polarity control signal T2 (FIGS. 9B and 9C). The voltages V2′ and V4′ are illustrated in FIG. 9F.

Therefore, as illustrated in Table 2, other than the period in which the high impedance control signals T31 to T38 are at the H (high impedance) level, the correction voltage is applied via the V2′ power line or the V4′ power line.

The basic operation of the present example is now described. The high impedance control signals T31 to T38 are fixed at the L level. When a waveform distortion occurs in the scanning side voltage, a correction voltage such as to correct that distortion is superimposed over the signal voltage of the signal side driving circuit 22 before that signal voltage is applied. Thus, in Example 2, as illustrated in FIGS. 9H and 9I, the final output voltages on the signal side are as those illustrated in FIGS. 4G and 4H (Example 1). As a result, it is possible to apply a signal voltage superimposed with a correction voltage during a scanning period immediately after the time when the voltage of the signal electrode changes in accordance with the display data.

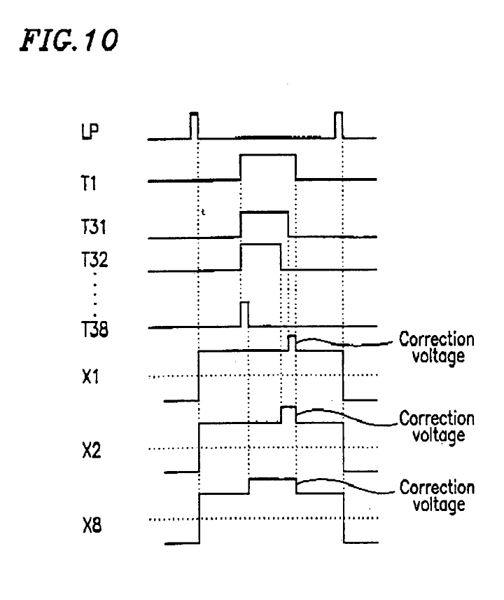

The advantage of the present example is that only 2 output levels of signal side driving circuit 22 are required, and the cost of the device can therefore be reduced. Since a correction voltage is superimposed over a common voltage line in the present example, in order to correct the difference in the waveform distortion due to the position of the scanning side electrode, as described in Example 1, the high impedance control signals T31 to T38, respectively for the signal electrodes, each having a timing slightly different from that of the next signal (see FIG. 10) are used, so that the correction voltage is applied on each of the signal electrodes at a timing shifted from the timing at which the correction voltage is applied on the next signal electrode.

In the present example, the high impedance control signals T31 to T38 are generated by the control circuit 25. In practice, however, the circuit for generating the high impedance control signals T31 to T38 can be provided in the signal side driving circuit 22.

As described above, it is possible, as in Example 1, to compensate for the decrease in the effective voltage due to the waveform distortion in the scanning voltage, by applying, from the signal electrode side, a correction voltage corresponding to the waveform distortion in the scanning voltage. As a result, crosstalk can be greatly reduced.

Moreover, as is apparent from FIG. 6, the structure of Example 2 only requires a number of power lines extending between the power circuit 24 and the signal side driving circuit 22 and a number of switching elements of the output driver 35 in the signal side driving circuit 22 which numbers are each ⅓ of those required in the structure of Example 1 illustrated in FIG. 1. As a result, the chip size of the signal side driving circuit 22 (normally integrated into an IC chip) is greatly reduced, thereby providing great advantages in reducing cost and size of the device.

While Examples 1 and 2 of the present invention have been described above, the present invention is not limited to those examples. For example, while externally-input signal is used as the correction period control signal T1 in the above example, the signal T1 may alternatively be generated inside the signal side driving circuit 22.

Moreover, the method for driving the liquid crystal panel according to these examples is based on the voltage averaging method where when the non-selection potential on the scanning electrode side (V3) is represented by GND and the bias ratio by 1/a, then ±Vop(1-1/a) is applied as the scanning electrode side selection potential (V1, V5), and ±(Vop/a) is applied as the voltage (V2, V4) according to the display data to be applied on the signal electrode side. However, the present invention is not limited to this, but the driving method may be such that the values Vop(1-1/a) and Vop/a are used as two different non-selection potentials on the scanning electrode side, and the values Vop and GND are used as the corresponding selection potentials, while potentials Vop and Vop(1-2/a) or 2Vop/a and GND are applied on the signal electrode side according to the display data. In such a case, however, since there are four signal potentials required for the signal side driving circuit, it may be necessary to accordingly increase the number of correction voltages.

Moreover, the present invention can similarly be used to reduce crosstalk which occurs due to a waveform distortion, in a pulse width modulation type or amplitude modulation type LCD device as well as in an LCD device which is capable only of a binary display (including those performing a gray-scale display using the FRC (Frame Rate Control)).

### EXAMPLE 3

While the above-described examples each provide a sufficient crosstalk correction affect in normal situations, precise correction without depending upon the driving voltage, the temperature and the frame frequency con be provided by generating a correction voltage generation signal in accordance with Example 3 of the present invention.

Since crosstalk occurs due to the capacitance of the liquid crystal layer, the degree of crosstalk varies depending upon those factors which affect the capacitance (e.g., the driving voltage, the temperature and the frame frequency).

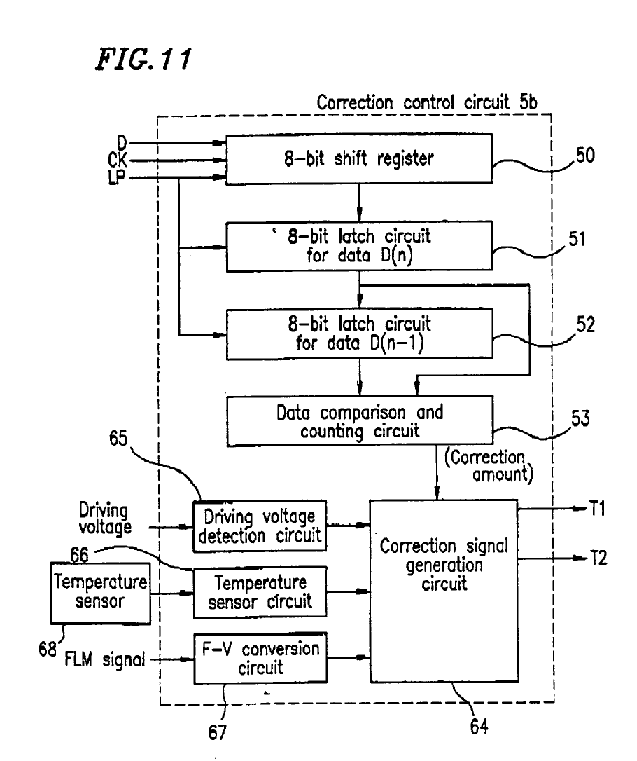

To account for this, a correction control circuit 5b illustrated in FIG. 11 can be used to count the number of changes in the display data D from one scanning electrode to the next scanning electrode, which is a cause for a waveform distortion, so as to determine a correction amount according to the count. The “number of changes in the display data D” herein means the number of data points of all the data points along one scanning line being scanned now whose values have changed from those at the previous scanning line.

Then, the determined correction amount is weighted with valves such as the driving voltage, the temperature and the frame frequency.

The correction control circuit 5b includes a correction signal generation circuit 64 on the output side of the data comparison and counting circuit 53 of the correction control circuit 5a illustrated in FIG. 3A. Input to the correction signal generation circuit 64 are: driving voltage data detected by the driving voltage detection circuit 65 for detecting a driving voltage; temperature data obtained by a temperature sensor circuit 66 for detecting the temperature of the environment where the LCD device is used or the temperature of the LCD device itself by receiving a signal from a temperature sensor 68 provided in the environment around the device or in the device itself; and voltage data obtained by an F-V conversion circuit 67 for receiving the scanning start signal FLM and converting the change of the frame frequency (F) to the change of the voltage (V) to compensate for the frequency characteristics of crosstalk, the degree of which varies in accordance with the frame frequency. Each of the sections in the correction control circuit 5b which are provided with the same reference numerals as those in the correction control circuit 5a illustrated in FIG. 3A have the same function as that in the correction control circuit 5a.

Hereinafter, the operation of the correction control circuit 5b illustrated in FIG. 11 will be described.

The basic operation of the correction control circuit 5b is the same as that of correction control circuit 5a. The correction amount obtained as in Example 1 is weighted with various data from the driving voltage detection circuit 65, the temperature sensor circuit 66 and the F-V conversion circuit 67 so as to provide correction based on the voltage, the temperature and the frequency. These corrections are adjusted as a function based on the data previously stored in the conversion circuit inside the correction signal generation circuit 64 so that changes to the corrections are in accordance with the temperature characteristics and the frequency characteristics of the liquid crystal panel used. It is noted, however, that the conversion circuit alternatively be provided externally to the correction signal generation circuit 64.

Due to such a structure of the correction control circuit 5b, the pulse width of the correction pulse used or correcting crosstalk changes so as to be the moot appropriate correction amount based on the driving voltage, the temperature and the frame frequency. Therefore, crosstalk can be greatly reduced under any conditions.

The correction pulse width control circuit has been shown to be one independent circuit in the present example. However, components of the correction pulse width control circuit (e.g., the shift register, the latch circuit) are those which are usually included in the signal side driving circuit, and it is thus possible to alter the structure of the signal side driving circuit so as to include these functions therein.

It should be understood that while an analog circuit is partly used in the present example, a digital circuit can alternatively be used as long as it provides the same or similar function.

In FIGS. 1 and 6, the scanning aide driving circuit 3 is provided only along one side of the scanning lines Y1 to Y8. However, the present invention is not limited to such a structure, and the scanning side driving circuit 3 can be provided along each side of the scanning lines Y1 to Y8. In such a case, the correction voltage illustrated in FIG. 10 can be varied in accordance with the distance from the closer one of the scanning side driving circuits.

As described in detail above, typically when the display data for a scanning electrode (scanning line) is varied from the display data for the preceding scanning line, a waveform distortion is generated in the scanning voltage according to the variation therebetween. In the present invention, however, a correction voltage (pulse) whose pulse amplitude or pulse width is changed according to the variation in the display data is applied from the signal electrode side, whereby it is possible to correct the effective voltage decrease due to the waveform distortion generated in the scanning voltage. Thus, it is possible to provide a substantially constant effective voltage for all the pixels, thereby greatly reducing crosstalk.

Since the correction amount is determined based on the amount of change from the data of the preceding scanning line, it is possible to prevent not only the above-described crosstalk from occurring due to the waveform distortion of the scanning voltage, but also other types of crosstalk from occurring (e.g., crosstalk occurring when displaying a vertical alternating stripe pattern, crosstalk where the top portion and the bottom portion of a vertical black line drawn on a white background become brighter than the rest of the line, crosstalk occurring along a dotted line or a line in any direction on the screen, and crosstalk occurring in an area of the screen).

The present invention is not influenced by variations in those factors which affect the degree of crosstalk (e.g., the display pattern, the temperature and the frequency). Therefore, crosstalk can be greatly reduced under any conditions, thereby greatly improving display quality.

Various other modifications will be apparent to and can be readily, made by those skilled in the art without departing from the scope and spirit of this invention. Accordingly, it is not intended that the scope of the claims appended hereto be limited to the description as set forth herein, but rather that the claims be broadly construed.

What is claimed is:

1. A liquid crystal display device, comprising;
a liquid crystal panel having a plurality of signal electrodes and a plurality of scanning electrodes which are arranged to cross each other with a liquid crystal layer interposed therebetween;
a scanning side driving circuit for sequentially applying scanning voltage to the plurality of scanning electrodes;
a signal side driving circuit for applying voltages to the plurality of signal electrodes, the voltage being determined by superimposing, for a corresponding scanning period, a correction voltage such as to correct a variation in an effective voltage due to a waveform distortion occurring in the scanning voltage over a signal voltage corresponding to display data; and
a voltage generation circuit for generating voltages required for driving the signal side driving circuit and the scanning side driving circuit.

2. A liquid crystal display device according to claim 1, wherein the correction voltage is generated as a function based on a correction voltage generation signal predetermined in accordance with prescribed data.

3. A liquid crystal display device according to claim 1, wherein the correction voltage is a pulse voltage, and a pulse width or pulse amplitude of the pulse voltage is changed in accordance with an amount of change of the display data over consecutive scanning periods.

4. A liquid crystal display device according to claim 1, wherein the correction voltage is a pulse voltage, and a pulse width or pulse amplitude of the pulse voltage is changed for each one or more of the plurality of signal electrodes in accordance with a distance between the one or more of the plurality of signal electrodes and a scanning side driving circuit which is connected to at least one end of the plurality of scanning electrodes.

5. A liquid crystal display device according to claim 1, wherein the voltage generation circuit:
generates at least the signal voltage and a corrected signal voltage, which is obtained by superimposing the correction voltage over the signal voltage; and
selectively supplies one of the signal voltage and the corrected signal voltage to the signal side driving circuit based on whether the correction voltage is superimposed over the signal voltage.

6. A liquid crystal display device according to claim 1, wherein the voltage generation circuit:
generates et least the signal voltage and a corrected signal voltage, which is obtained by superimposing the correction voltage over the signal voltage;
supplies the signal voltage and the corrected signal voltage to the signal side driving circuit; and
selects one of a plurality of output lines based on whether the correction voltage is superimposed over the signal voltage.

7. A liquid crystal display device according to claim 2, wherein the prescribed data comprises at least one of: a temperature of an environment in which the liquid crystal display device is placed; a temperature of the liquid crystal display device itself; a driving voltage applied to the liquid crystal display device; and a frame frequency at which the liquid crystal display device is driven.

8. A method for driving a liquid crystal display device, the device comprising: a liquid crystal panel having a plurality of signal electrodes and a plurality of scanning electrodes which are arranged to cross each other with a liquid crystal layer interposed therebetween; a signal side driving circuit for applying a voltage, required for performing a display on the liquid crystal panel, to the plurality of signal electrodes; a scanning side driving circuit for sequentially applying a scanning voltage to the plurality of scanning electrodes; a voltage generation circuit for generating voltages required for driving the signal side driving circuit and the scanning side driving circuit, the method comprising the steps of:
(a) generating a correction voltage generation signal, which is used for weighting a correction amount for correcting an amount of change of the display data over at least two consecutive scanning periods;
(b) obtaining a correction voltage which is a pulse voltage whose pulse width or pulse amplitude is variable based on the correction voltage generation signal;
(c) superimposing the correction voltage over the signal voltage corresponding to the display data for performing a display on the liquid crystal panel; and
(d) supplying, to the plurality of signal electrodes, the signal voltage over which the correction voltage to superimposed.

9. A method according to claim 8, wherein the prescribed data comprises at least one of: a temperature of an environment in which the liquid crystal display device is placed; a temperature of the liquid crystal display device itself; a driving voltage applied to the liquid crystal display device; and a frame frequency at which the liquid crystal display device is driven.

10. A method according to claim 8, wherein the correction voltage generation signal is generated for further weighting a correction amount for correcting an amount of change of the effective voltage due to a waveform distortion occurring in the scanning voltage depending upon a distance between each of the plurality of signal electrodes and the scanning driving circuit.
